(19) United States
(12) Patent Application Publication
(10) Pub. No.: US 2014/0029797 A1
(43) Pub. Date: Jan. 30, 2014

(54) METHOD FOR LOCATING ANIMAL TEATS

(71) Applicant: Andreas Eriksson, Sodertalje (SE)

(72) Inventor: Andreas Eriksson, Sodertalje (SE)

(73) Assignee: DELAVAL HOLDING AB, Tumba (SE)

(21) Appl. No.: 14/008,728

(22) PCT Filed: Mar. 26, 2012
(86) PCT No.: PCT/SE2012/050333

§ 371 Date: Sep. 30, 2013

Related U.S. Application Data
(60) Provisional application No. 61/468,172, filed on Mar. 28, 2011.

(30) Foreign Application Priority Data
Mar. 28, 2011 (GB) 1105136.4

(51) Int. Cl. G06K 9/00

(52) U.S. Cl. CPC G06K 9/00362
USPC 382/103

(57) ABSTRACT

A method and apparatus for locating teats of an animal uses an automated three-dimensional image capturing device and includes automatically obtaining and storing a three-dimensional numerical image of the animal that includes a teat region of the animal; making the image available for review by an operator; receiving manually input data designating a location of the teats in the image; from the designated location of the teats, creating a teat position data file containing the location co-ordinates of each defined teat from within the image; updating an animal data folder with the teat position data file. The method references the teat position data file containing the location co-ordinates of each defined teat during an animal related operation involving connecting a milking or cleaning apparatus to the teats of an animal.

### BACKGROUND

The present invention relates to improvements in the determination of teat positions of dairy animals using automated camera equipment. It may be of particular utility in the dairy industry in which herds of animals are kept and managed.

In automated milking, methods for automatic teat cup attachment have previously been developed which include the automatic detection of teat positions. A method of detecting and recording teat positions in connection with a teat cup attachment and milking robot at a milking stall is taught for example in EP-A-0360354. According to this document, teat detection and location is said to be carried out by means of triangulation using a laser emitter and detector device. The position detection apparatus is mounted on a robot and operates on the basis of a previously stored position for the udder and teats of each identified animal. It has also been suggested, for example in US200210033138, to utilise robotic teat cup attachment means at a rotary platform type milking parlour in which animals enter successive parlours as the platform rotates. In U.S. Pat. No. 7,490,576, it has furthermore been suggested to utilise a so-called time of flight camera for carrying out an improved automatic teat location.

Although developments in teat detection have been made, it nevertheless can occur that an animal which presents itself for milking and which undergoes an automated teat detection operation in order to carry out automated teat cup attachment, may not be able to be milked owing to a failure to correctly detect or identify or locate its teat. This may occur in some cases where a system may be unable to make appropriate determinations concerning an animal's teats, such as when an animal has a missing or additional teat. It can also occur in cases where the teat layout in relation to a camera is such that the camera cannot distinguish each teat. In some cases, two teats may appear as one. Difficulties in making correct determinations in relation to animals' teats tend to occur most frequently in animals in respect of which not all parameters are known to the system, especially in animals which are entering a system for the first time or which have not entered the system for a long period.

In such cases, it has been known for a technician to intervene in an automated teat searching procedure and to manually “teach” a robot the positions of an animal's teats, e.g. by manually operating the robot to the required teat positions. This requirement places a need for an operator to be on hand at short notice in an automated facility and it slows down the operation of the facility, because manual teaching takes more time than an equivalent automated procedure.

The present invention provides an improved apparatus and method for the correct determination of teat locations in relation to individually identified animals.

### SUMMARY OF THE INVENTION

A method according to the invention is defined in appended claim 1. Preferred embodiments thereof are defined in subclaims 2-11. A method for carrying out an operation on an animal's teats utilising a teat locating method according to the invention is defined in claim 13. An apparatus according to the invention is defined in appended claim 14. Further embodiments thereof are defined in subclaim 15. The invention may in particular be applicable in animal installations, especially dairy animal installations which include automated equipment for treating animals, in particular for milking animals and/or for cleaning animals, including cleaning animal teats in connection with a rotary platform comprising multiple stalls or in connection with a voluntary milking type robot stall.

According to the invention, there is provided a method for locating the teats of an animal, which method is carried out using an automated system including automated three-dimensional image capture means, image data storage means, data processing means, information display means and data input means. According to the method, certain information pertaining to the identification of teats in a captured three-dimensional image are input manually. Preferably, the data processing means is capable of carrying out tasks such as e.g. image analysis using algorithms for determining those shapes in an image which correspond to target shapes of animal body parts. The method of this invention may be carried out in connection with a fully automated method for teat seeking, teat locating, teat identification and teat position determination. In particular, the method of this invention may be carried out in connection with an aforementioned fully automated method in cases where one or more aspects of teat position detection are incomplete or result in errors. As such, the method of the invention ensures the efficient and reliable acquisition of teat position information in cases where a fully automated method has resulted in an incomplete or erroneous data set.

According to the invention, animal teats are located using an automated three-dimensional image capturing device such as a “Time of Flight” (TOF) camera or stereoscopic camera associated with image data storage means and data processing means. The term “locating” in this context signifies the determination of the spatial location of teats. The teat locating apparatus may in particular be associated with teat cup attachment apparatus or other teat treatment apparatus. The method comprises the step of automatically obtaining and storing one or more three-dimensional numerical image which includes or which is expected to include the teats of said animal. In general, the image or images will contain one or more views which capture the udder of an animal from below and to one side. In this context, a numerical image is an image whose individual component parts are defined digitally. In particular, in the context of a TOF camera, individual image components such as pixels are defined in terms of spatial co-ordinates including a depth (distance) value, wherein such depth values are recorded in relation to the TOF camera position. There may be performed an image analysis using algorithms. In particular, there may be performed an analysis of one or more images in order to determine teat candidates within the image.

Subsequently, one or more images are made available for review by an operator. The images to be made available may be still images selected from among a video image sequence using the camera. Alternatively, the images may be still images captured from certain positions nearby and around the target area, which may be one or more predetermined image capture positions. For example, in case automatic analysis of video images for teat position information is inconclusive, erroneous or incomplete in some respect, then an image acquisition routine may be initiated in which one or more still images is taken from among a sequence of video images or in which one or more still images is captured from one or more predetermined positions nearby and around the target area. The images may be made available using any suitable graphical user interface (GUI) enabling an operator to review image content and details therein in order to see and identify the locations of teats within the image. Having seen the animal's teats within one or more images, an operator may enter relevant data into the automated system.

As such, in a next step, manually input data identifying and designating the location of one or more teats in the one or more numerical image is received by the automated system. In practice, from the operator's point of view, the teat locations in an image may be selected or confirmed. This may be carried out for example by allowing an operator to select the teats of an animal at the place in an image where they are visible, e.g. by using a mouse device to “click” at a displayed teat, for example at the displayed tip of one or more teats. The information which is entered may be fed into a relevant memory of the automated three-dimensional image capturing device associated with image data storage means and data processing means. In particular, the teat location information in relation to an image may be received in a register and converted automatically into position co-ordinates before it is stored in a dedicated memory such as a data file. In this manner, the system generates and acquires a precise mapping of the teats of an identified animal.

Once the teat position data comprising the location co-ordinates of each defined teat from a numerical image or images have been determined, they are stored by creating a teat position data file into which the data are placed. Following this, an animal data folder for a relevant identified animal is updated with the teat position data file.

According to a further embodiment, the step of receiving manually input data may further include receiving data which identifies one or more teats in the numerical image or images. The identification of a teat may for example take the form of entering or selecting a character set which serves to describe and/or identify a particular teat and may relate to its positional designation. A typical identification may be e.g. “LF” for the left front teat, “RR” for the right rear teat and so forth. According to this feature, the manually input data serves to identify the relevant teat in the implementing system's operating code. In the example given above, the designations are also recognisable by human operators.

In a further optional aspect, the attribution of teat identities to manually indicated teat locations is carried out automatically using the data processing means. According to this feature, an operator may select locations within an image which correspond to teat positions, and respective teat identity designations are automatically derived by the data processing means and attributed accordingly. For example, an operator selecting locations in an image, each of which corresponds to a teat, will automatically or manually initiate a processing cycle in the data processor which will attribute the correct respective teat identity designation using the TOF camera depth information in addition to the image pixel data.

In another optional aspect, the method of the invention further includes performing automated image analysis in order to identify and generate so-called teat candidates within the image or images. According to this feature, the system automatically scans and analyses a TOF camera image in order to extract three dimensional patterns which correspond to possible teat shapes. The most likely teat patterns may be selected from among the patterns which are identified. Algorithms may serve to further filter out less likely teat candidates from among the possible shapes which are identified. After analysis by a data processing means, the image may then be presented with superposed probable teat designations selected from the extracted patterns for a particular image. Each teat candidate may thus be denoted by a symbol or character string superposed on a numerical image. An operator may then merely confirm the location of teats within the image, in case one or more teat candidates has been correctly identified by the system. In some cases, where the system presents an operator with incorrectly labelled features in an image, labelling may be selected and moved by the operator to a correct location in the image, or additional labels may be entered by the operator.

According to another optional aspect, a set of one or more position vectors may be created using data processing means. In this context, a teat position vector defines a teat position in terms of the relative position of the teat in relation to one or more other teat positions. The derived position vectors may be stored as teat position vectors which define a teat position in relation to one or more other teat positions. Accordingly, where the absolute teat position co-ordinates of one teat of an animal are known, then one or more remaining teat positions may be defined in terms of co-ordinates which are relative to the known teat position. In some cases, any given teat position may be defined in terms of either or both, absolute teat location co-ordinates and position vectors.

In order to reliably obtain an image or a set of images which contains the relevant parts of the body of an animal, i.e. teats, then according to the method of the invention, a camera is preferably directed towards a predefined given region of a milking stall. Alternatively, in another aspect, a three-dimensional numerical image or images, which includes or which is expected to include the teats of said animal, may be created using a camera which is directed towards a predefined region in relation to a detected position of an animal. For example, a sensor such as a moving back-plate contacting an animal, may provide a signal indicating the animal's position, allowing a determination of the appropriate camera position to be made. A position sensor may alternatively be a non-contact sensor such as an optical sensor, which may include a TOF camera directed towards an animal or towards a part of an animal. A TOF camera for this purpose may continually or intermittently record the position of an animal e.g. in a stall.

In a further aspect, the method of the invention may use one or more three-dimensional image capturing devices located on a robot arm. One or more images to be made available to an operator may in particular be captured during an automated teat identification and location routine. To this end, a camera may advantageously be moved near and beneath the teats of the animal. Such an automated routine may be a standard routine performed on animals when they enter a particular location such as a stall. In the majority of cases, such a routine leads to the positions of an animal's teats being identified as a result of image analysis by data processing means. In cases where the exact teat positions are not identified or only partially identified, or are identified but obviously incorrect, images obtained during the standard imaging routine may be stored in order to be made available to an operator for review and confirmation of teat locations in the image. In some embodiments of the method of the invention, still images may be made during routine imaging of an animal. In other aspects, still images may be created from video image sequences obtained during a standard imaging routine.

In a further optional method step, the teat location information derived from an image may be received by means of an operator selecting (e.g. mouse-clicking) a screen location in a visual image obtained from a three-dimensional numerical image. The selected location may in particular correspond to the visually displayed position, in said visual image, of the tip of a teat. Other parts of a teat may alternatively serve to be selected for this purpose according to the requirements of any given system and method implementation.

In further optional embodiments, the successive method steps of the invention are performed if, after initial method steps of automatically capturing and analysing camera images of an identified animal including its udder and teat region, said analysis reveals that teat location determination in respect of said animal is incorrect or incomplete. A determination as to the correctness or completeness of the teats which are automatically identified in an image can be made using dedicated algorithms. According to this aspect, the method step of automatically capturing and analysing camera images is part of a fully automated teat imaging and locating method. If this embodiment is practiced for example in the context of a milking platform, then an animal may remain in its stall on the platform in spite of there having been no successful cup attachment. The progress of the platform need not be delayed or interrupted for performing a manual teaching of teat positions into the robot, because the teaching of teat positions can be carried out “offline”, that is to say, it can be carried out at a non-critical moment for the progress of overall operations at an installation. When an animal later re-enters the platform, its teat positions will have been taught and stored in the system memory, allowing e.g. teat cup attachment to be carried out automatically without further manual intervention.

In a further optional aspect, the method of the invention may be carried out in the context of an animal related operation performed on animal teats using robotic apparatus. Accordingly, for example, a method for automatically cleaning one or more teats, whether by way of pre- or after-treatment, or for attaching one or more teat cups to teats of an animal, may be carried out utilising a robot arm, wherein the step of teat-cleaning or teat cup attachment is carried out in respect of one or more teats which have been located following the method of the invention, i.e. using manually input teat location data on the basis of automatically gathered teat images.

The image capture means for use in connection with the present invention may be any suitable image capture means capable of creating three dimensional images of an animal or parts of an animal. Examples include stereoscopic cameras and time-of-flight (TOF) cameras. One example is a camera known under the trademark SwissRanger, made by MESA Imaging AG. TOF cameras produce an image made up from many individual pixels, each of which pixels includes, in addition to shade or colour, a depth measurement indicating the distance between the camera and the part of the image represented by the relevant pixel. Parameters relating to each pixel, such as shade, colour and depth parameters may be stored in digital form, thereby creating a numerical image file.

The invention also relates to an apparatus adapted for implementing the method of the invention, suitably in co-operation with an operator capable of manually inputting appropriate data if necessary and optionally, at a time which is not critical to overall operation of an installation. The apparatus comprises at least one automated three-dimensional image capturing device associated with image data storage means and data processing means. The image capturing device may in particular include a TOF camera or stereoscopic camera. The apparatus of the invention further comprises a graphical user interface (GUI) capable of displaying a visual image corresponding to a captured three-dimensional numerical image. Preferably, the display is a screen type display which may be a touch screen or which may be a screen associated with other input means such as a mouse or keyboard. Input means are capable of allowing manual entering of teat position information in relation to a displayed visual image. In aspects of the invention, the GUI is preferably capable of displaying more than one image and of allowing a user to select an image from among a number of displayed images.

The apparatus may in particular form part of a rotary type animal treatment platform such as a milking platform or it may form part of a voluntary robotic milking parlour arrangement.

### EXAMPLES

The invention will be better understood with reference to aspects thereof which are illustrated by way of non-limiting examples in the appended drawings.

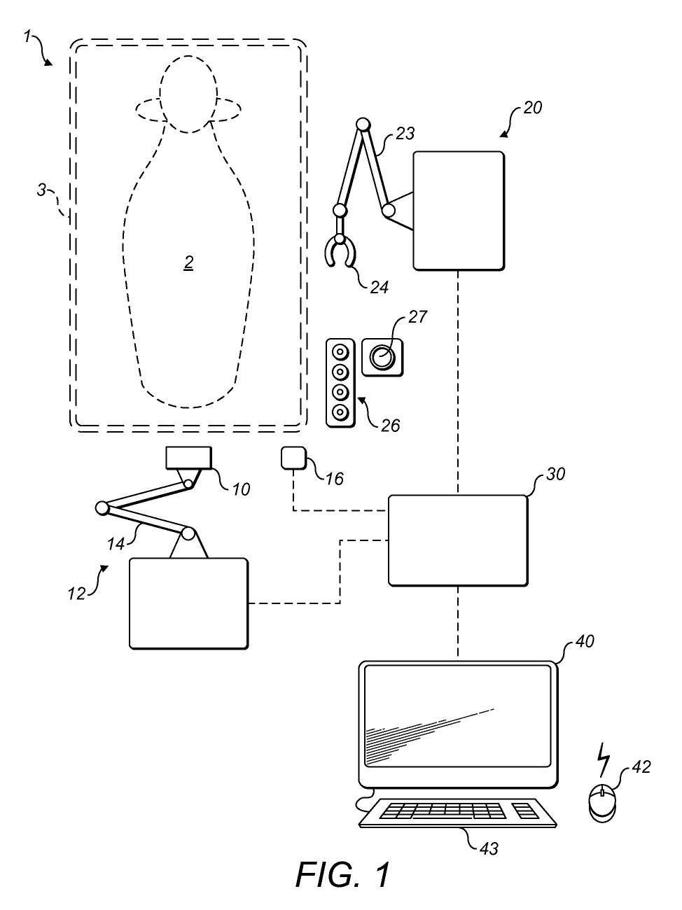

FIG. 1 shows a simplified schematic view of elements of an apparatus according to the invention.

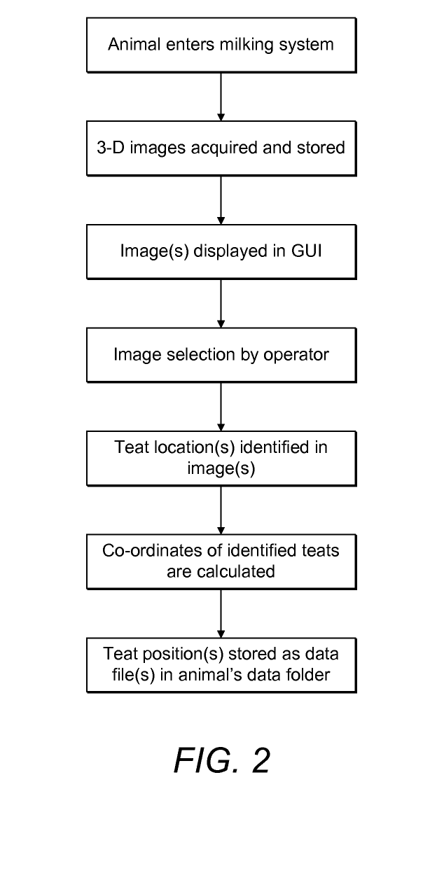

FIG. 2 shows a flow chart summarising an example of a method according to the invention.

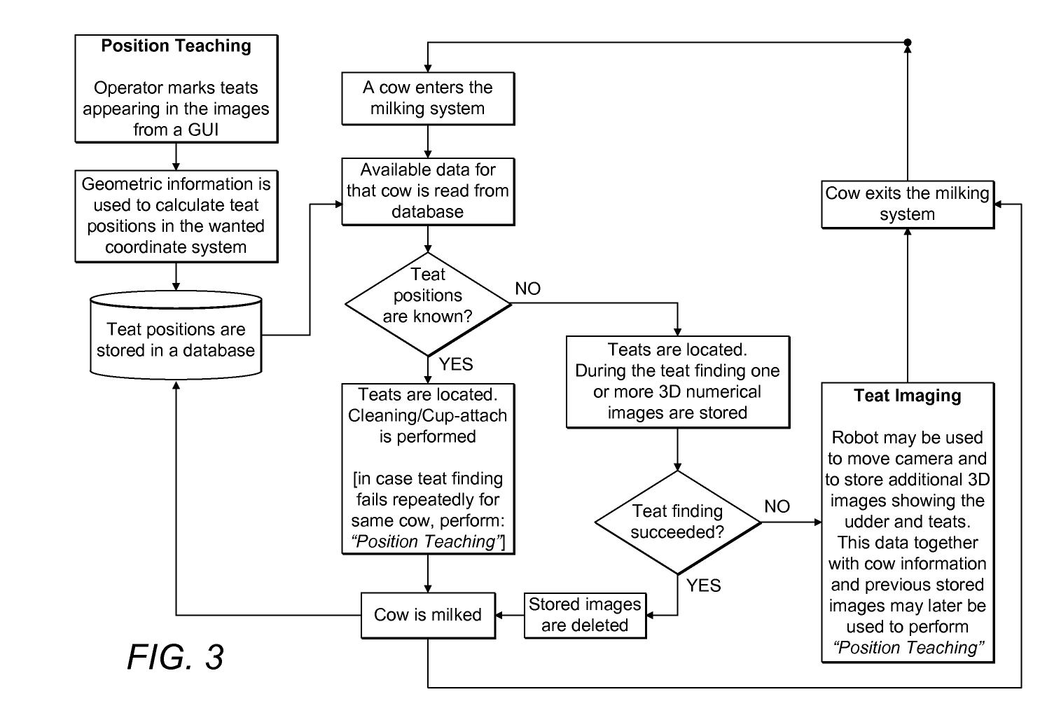

FIG. 3 shows a flow chart summarising a further example of a method according to the invention.

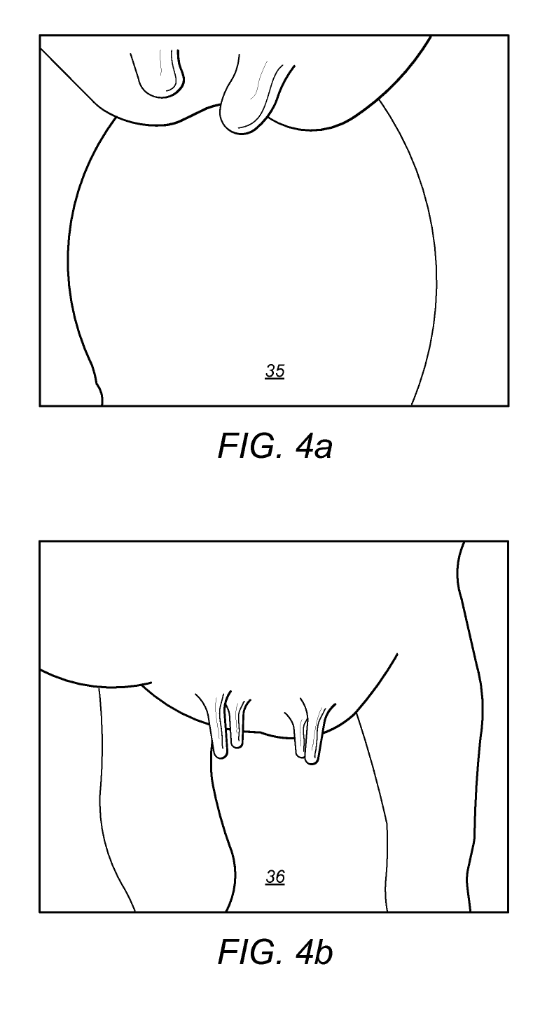

FIGS. 4a-c show views of sample images collected by a camera used in accordance with the invention.

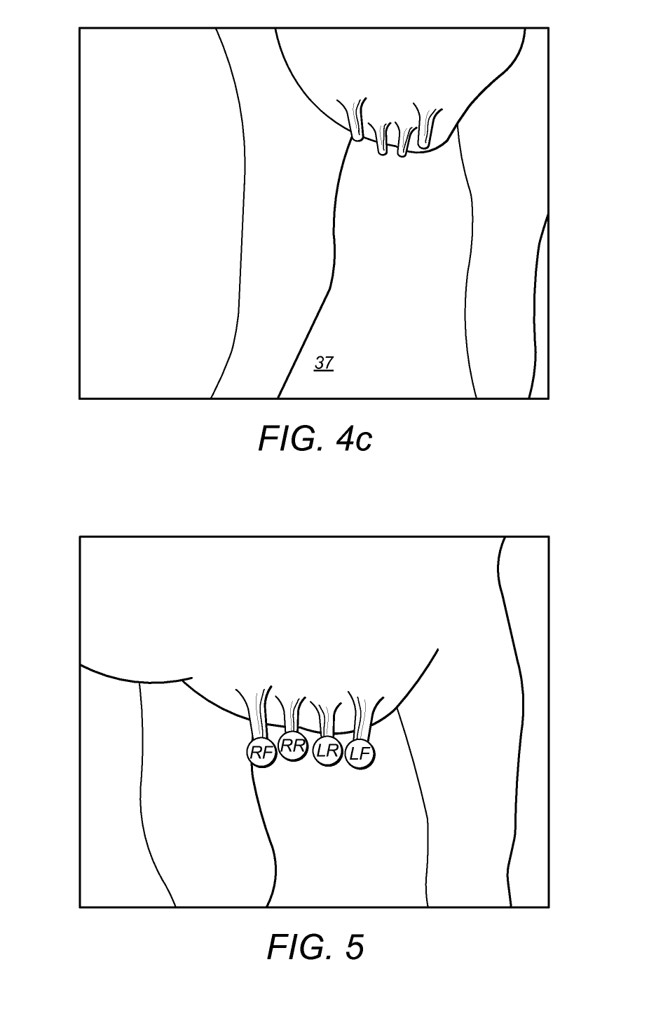

FIG. 5 shows an example of identification applied to individual teats in an image collected and presented according to the invention.

A schematic layout of elements of an apparatus 1 suitable for carrying out the invention is shown in FIG. 1. An animal 2 is present at a stall 3 which may be any kind of animal treatment stall such as a feeding stall or a cleaning stall or, most particularly, a milking stall such as a stall for automatic milking. The stall 3 may be part of a more substantial installation possibly comprising multiple stalls and possibly in the form of stalls on a rotary platform known per se (not shown). A robot 20 is provided nearby the stall 3. In the example shown, the robot 20 is a treatment robot capable of carrying out animal treatment steps such as attaching cleaning or milking devices to the teats of an animal. A cleaning device 27 and a magazine of milking cups 26 are shown alongside the stall 3. The cups 26 and cleaning device 27 and/or the robot 20 may equally be positioned at an alternative location in relation to the stall 3 such as at a rear end of the stall 3. In case stall 3 is on a rotary platform, then it, along with neighbouring stalls (not shown) is moved to a position adjacent the robot 20 for attachment or detachment purposes of cleaning or milking cups for another treatment step, before being progressively moved to successive positions (not shown) along the platform path. Attachment of cups 26 or cleaning means 27 is carried out using a claw 24 at the end of an articulated robot arm 23 capable of moving the claw 14 from outside the stall 3 to the body of the animal 2, especially its udder.

A further robot 12 is shown positioned adjacent the stall 3 and includes a camera 10 at the end of an articulated robot arm 14. The camera 10 may be any suitable type of camera capable of making three-dimensional images of a subject in its field of view. Examples include a stereoscopic camera and a TOF camera. In some embodiments a camera 10 may be placed at a fixed location in relation to a stall, so that the additional robot 12 may not be required. In still further embodiments, in order to provide different image views of one or more parts of an animal, there may be more than one camera 10, with each camera 10 being either fixed or movable. In yet further embodiments, one or more cameras 10 may be positioned on the arm of robot 20 so that the additional robot 12 may not be required. In embodiments, there may be an animal position detector 16 connected to the control device 30 serving to relay the approximate position of the animal in relation to the stall and/or in relation to the camera 10. The sensor 16 is indicated figuratively in FIG. 1 and may for example be an optical position detector or it may comprise a physical sensor which contacts the animal and monitors its position.

A control device 30 in the form of a computer is connected to the robots and also to a display interface 40. The computer of the control device 30 may control additional elements of an installation or it may communicate with an installation control system (not shown). It combines at least data processing means, memory means and control means including appropriate control software and GUI software. Memory means in the control device may in particular include a data folder for each animal, containing a set of specific data files, each relating to aspects of the animal for which records are kept. For example, there may be contained in an animal's data folder indications concerning its expected milk yield, its age and dimensions. There may also be recorded special indications concerning the number of teats which the animal has (some animals have more or fewer teats than the usual number).

The robotic and control elements of the apparatus are preferably capable of enabling the system to operate fully automatically for carrying out treatments on animals which may in particular include milking or cleaning operations or both or other operations. Advantageously, a GUI displays status information through the display 40 relating to the robot operations and allows a variety of display modes to be selected. The GUI operates by means of the display 40 combined with suitable input means such as a mouse 42 and/or keyboard 43. Alternatively, the display 40 may be a touch screen display, allowing operators to input commands or information to the system control 30.

With reference to examples of FIGS. 1 and 2, when an animal enters a stall 3, which may be a milking stall or other stall, it is identified in a manner known per se and its presence at the stall is registered in or notified to the control device 30. Relevant records for the animal are retrieved from within an individual animal data file stored in the control device 30 memory. Then the camera 10 will be used for detecting the location of animal teats for the purpose of enabling the performance of treatments (i.e. operations) such as automatic attachment of pieces of apparatus such as a cleaning cup 27 or teats cups 26 to the animal 2. To this end, three dimensional numerical images of a part of the animal 2 including its udder and teats are made using the camera 10 and possibly the robot 12, under the control of the control device 30. The images may be video sequence images or individual still images and they may be taken from a particular prescribed standard position in relation to the stall 3 or in relation to the animal 2. The camera 10 may be moved to a particular location in relation to the stall 3, or in relation to the animal 2, using data from the sensor 16. Following this, three dimensional video images or one or more three-dimensional still images are analysed in order to determine the features present within the field of view. One or more relevant images 35, 36, 37 (see FIGS. 4a-c) are stored in the data folder for the animal concerned. At a later stage, or concurrently with the presence of the animal at the stall 3, an operator may be presented with one or more images 35-37. Optionally, in case more than one image is presented, or in case the image which is presented is not usable, an operator may choose an image from among the images presented or may choose an alternative image. In case no images are usable, then a new imaging routine may be needed until a usable image is obtained. In the example of FIGS. 4a-c it is apparent that the image 35 may not be usable because it contains only a partial view of the area of interest. According to aspects of the invention, a determination concerning incomplete or unusable images may be made automatically using appropriate algorithms. Such algorithms may nevertheless occasionally produce an erroneous result, especially when the animal in question has a highly atypical teat layout or number of teats. In some cases, incomplete images may be combined with other partially complete images to create a complete or more complete image.

From image 37 an operator may manually identify the teat locations in the image by appropriate input means in accordance with a GUI. For example, the operator may manually select the respective areas on a display which correspond to each of the teats which are visible and may input a designation for each teat corresponding to its arrangement on the animal (e.g. LF, RF, LR, RR). Alternatively, a data processor may automatically determine a nomenclature for the selected objects (i.e. the teats) using the image numerical information to deduce the attribution of the designations to each of the selected locations in the image. This can be carried out automatically because the data processor is capable of using the numerical (depth) information in the image determining the relative spatial locations of the indicated objects in the image (i.e. teats). An example is shown in FIG. 5, in which the respective teat identifications are included in the image displayed by the GUI. The same means allows the system to perform a plausibility check in relation to the information which is input by an operator concerning the teat designations. When the designations of the respective teats have been correctly input by an operator using one or more images, the data processor makes a calculation of the co-ordinates of the teat positions and these are then stored in a relevant file on the individual animal's data folder. The co-ordinates may be stored in any appropriate format, such as vector co-ordinate format or absolute co-ordinates. The reference point which is used as an origin for co-ordinate values may for example be a camera at a given position or it may be a fixed position relative to a stall.

With the teat location information stored in this manner, it may subsequently be used for positioning a robot in order to immediately carry out an operation on the teats such as attachment of milking cups 26 or cleaning means 27. Alternatively, in case the relevant animal is no longer in the stall when the teat identification and information input by an operator is performed, the stored teat position co-ordinates may be used for ensuring that automatic teat cup attachment or cleaning or another teat related operation can be performed automatically without manual data input or image review.

According to further embodiments of the method of the invention, and with reference to FIG. 3: if it is intended to carry out a treatment on or in relation to the teats of an animal (e.g. milking or other treatment), then, after uploading data from the animal's data folder, the camera 10 may be activated to create images of the animal's teats. The images are converted if necessary into an appropriate numerical format containing both visual information and depth information for each pixel of the image. An analysis of one or more images using data processing capabilities of the control device 30 will serve to determine the shape and positions of the recorded features within the image. In order to ascertain which of the features in the analysed image are teats, a check may be carried out by the system implementing the method, whether a detection of teat positions for the animal in question has already been made and stored in the animal's data folder. If the teat positions have been previously determined and are stored in the animal data folder, then the relevant teat position data file is retrieved and teat positions for the ensuing automatic teat-related operation (e.g. milking or cleaning) can ensue.

On the other hand, it may be that no previous teat position information is available, possibly because the animal is passing through the apparatus for the first time. In such cases, the data processing means may nevertheless have sufficient information from the captured image or images or video sequence to recognise teat shapes and attribute identities to each one of the teats, in which case this can be carried out automatically prior to actuation of a robot means 20 for carrying out an operation such as milking in relation to the teats. This might be the case if, for example, one or more images which the system has captured contains a high level of clarity and completeness in relation to teat shapes, such as for example in image number 37. In such cases, the teat positions can be derived for successful automated operations relating to the teats (e.g. milking).

In some cases, not all of the teats can be recognised on the basis of the available images and the analysis which is carried out. If, in addition, no prior teat position information is available, it may be that no complete determination of teat locations in the available image or images or video sequence can be made. This might occur where the images are incomplete such as image 35, or it may occur when the images of teats contain one or more obscured elements, such as for example in image 36, in which the left rear (LR) teat is partially obscured by the left front (LF) teat. In some rare cases, animals' teats are arranged in an unusual configuration or there may be a teat missing or an additional teat present. If the prior teat position information were available, then it is possible that the image 36 could be correctly interpreted by the automated processing means. In its absence, one or more further attempts from other angles at image capture and analysis could appropriately be made. In case still no satisfactory attribution of teat locations can be carried out, then the image or images may be stored and may immediately or later be made available to an operator for review using the GUI and display means 40. The operator would then carry out so-called “position teaching” in accordance with the invention and as described above in the context of FIG. 2, and as illustrated on the left hand side of the flow chart of FIG. 3. If the position teaching is carried out immediately, then the animal may be treated, e.g. cleaned or milked, as intended. If the position teaching is carried out at a later time, then the animal is released from the stall without being treated, or kept on the platform stall if the stall is on a rotary platform, while its image information is stored in its relevant data folder for presentation to an operator who can carry out position teaching before storing the position co-ordinate data of the teats in the relevant animal data teat co-ordinate file. Upon re-entering the stall on a subsequent occasion, the prior teat position information may be recalled for aiding the determination of teat positions.

FIG. 5 provides an example of an image which an operator might see after reviewing the designation of teats in an image, whether the naming of the respective teats has been carried out automatically or manually—or automatically with a manual review/correction.

The method of this aspect of the invention offers the particular advantage that image recognition can be carried out automatically, with an efficient auxiliary method provided in case for any reason the automated attribution of teat positions is not successful. In general, the method according to the invention provides a particular benefit when an animal passes through a stall and its automated robotic apparatus for the first time, or where for one reason or another, images obtained are not as clear as required for an automatic teat position determination.

Further features of the invention within the scope of the appended claims will be apparent to a skilled person.

1-15. (canceled)

16. A method for locating teats of an animal, comprising the steps of:
using an automated three-dimensional numeric image capturing device (10) and, under control of a control device (30) with a data processing unit, automatically making a three-dimensional image of a teat region of the animal, the teat region including or expected to include the teats of the animal;
under control of the control device, displaying the image on a display with a graphical user interface (GUI) for review of the image by an operator;
receiving, from the operator, manually input data designating a location of an identified teat in the image displayed on the display;
from the manually input data designating the location of the identified teat, creating a teat position data file containing location co-ordinates of the identified teat in the image displayed on the display; and
updating an animal data folder, of the animal, with the teat position data file.

17. The method of claim 16, wherein,
said step of making the three-dimensional image of the teat region of the animal includes storing the image in a memory of the control device.

18. The method of claim 16, wherein,
said receiving step receives, from the operator, manually input data identifying and designating the location of each teat in the image displayed on the display, and
said creating step creates the teat position data file with location co-ordinates of each identified teat in the image displayed on the display.

19. The method of claim 16, wherein, in said receiving step, the manually input data identifying and designating the location of the identified teat in the image displayed on the display, indicates a tip of the identified teat.

20. The method of claim 16, wherein,
the automated three-dimensional image capturing device, used in said step of making a three-dimensional image of the teat region of the animal, is one of a stereoscopic camera and a time of flight (TOF) camera.

21. The method of claim 17, further comprising the step of:
the control device performing an automated image analysis of said stored image and thereby generating teat candidates within said image,
wherein in said displaying step, the image is displayed on the display with the teat candidates identified for confirmation by the operator.

22. The method of claim 16, wherein, in said step of making the three-dimensional image of the teat region of the animal, the image capturing device (10) is directed towards a predefined region of a milking stall.

23. The method of claim 16, wherein, in said step of making the three-dimensional image of the teat region of the animal, the image capturing device (10) is directed towards a predefined region in relation to a detected position of the animal.

24. The method of claim 16, wherein, in said step of making the three-dimensional image of the teat region of the animal, the image capturing device (10) is located on a robot arm and said image is captured during an automated teat identification and location routine.

25. The method of claim 16, comprising the further step of:
after said updating step, attaching a teat cup to the identified teat by performing an automatic teat location operation using the location co-ordinates of the identified teat from the updated animal data folder of the animal.

26. The method of claim 16, comprising the further step of:
after said updating step, executing an automatic teat location operation for the identified teat using the location co-ordinates of the identified teat from the updated animal data folder of the animal.

27. The method of claim 26, wherein, when said automatic teat location operation fails, performing steps of i) making a second three-dimensional image of the teat region of the animal, ii) displaying the second image on the display, iii) receiving, from the operator, second manually input data designating an updated location of the identified teat in the image displayed on the display, iv) from the second manually input data designating the updated location of the identified teat, creating a new teat position data file containing new location co-ordinates of the identified teat in the second image displayed on the display; and v) updating the animal data folder, of the animal, with the new teat position data file.

28. The method of claim 16, wherein, said step of making the three-dimensional image of the teat region of the animal is performed with the animal being located on a rotary milking platform.

29. The method of claim 18, wherein, in said steps of i) creating the teat position data file containing location co-ordinates of the identified teat in the image displayed on the display, and ii) updating the animal data folder, of the animal, with the teat position data file, a data set is created using the data processing unit, the data set comprising one or more position vectors, the set of position vectors being stored as teat position vectors defining each teat position in relation at least one other teat position.

30. The method of claim 29, wherein in the teat position file, the location of each identified teat is stored in the animal position data folder in terms of both teat location co-ordinates and position vectors.

31. The method of claim 18, wherein, in said steps of i) creating the teat position data file containing location co-ordinates of the identified teat in the image displayed on the display, and ii) updating the animal data folder, of the animal, with the teat position data file, a set of one or more teat location co-ordinates is created using the data processing unit, the set of teat location co-ordinates defining each teat position in relation at least one other teat position.

32. The method of claim 16, wherein said making step makes plural of the three-dimensional image of the teat region of the animal, including a from-below view image and a side view image including the animal's udder.

33. The method of claim 32, wherein said displaying step displays, for review by the operator, said plural images on said display.

34. The method of claim 16, wherein said receiving step receives, from the operator, the manually input data designating the location of the identified teat in the image displayed on the display as a confirmation of a candidate teat location.

35. An apparatus that implements a method of locating teats of an animal, comprising:
a control device (30) with a data processing unit;
an automated three-dimensional image capturing device that, under control of a control device, automatically makes a three-dimensional numeric image of a teat region of the animal, the teat region including or expected to include the teats of the animal;
an image data storage unit operatively connected to the image capturing device, wherein the image data storage unit stores an animal data folder of the animal;
a display, operatively connected to the image data storage unit and the data processing unit, that provides a graphical user interface that displays the three-dimensional image of the teat region to an operator; and
an input unit, operatively connected to the graphical user interface, that provides operator manually input data designating a location of an identified teat as teat position information in relation to the displayed image,
wherein, the control device, from the manually input data designating the location of the identified teat, creates a teat position data file containing location co-ordinates of the identified teat in the image displayed on the display, and updates the animal data folder of the animal with the teat position data file.
